(19) United States
(12) Patent Application Publication
(10) Pub. No.: US 2004/0077291 A1
(43) Pub. Date: Apr. 22, 2004

(54) Antiparasite entrance gate for honey-bee populations

(75) Inventors: Robert G. Arthur, Leawood, KS (US); Michael Grosse-Bley, Koln (DE); Hans-Dieter Hamel, Koln (DE); Josef Heine, Leverkusen (DE); Ulrich Heukamp, Kurten (DE); Michael Traeubel, Koln (DE); Otto Wilinski, Leichlingen (DE); Nikolaus Koeniger, Oberursel (DE); Stefan Fuchs, Darmstadt (DE)

Correspondence Address: JEFFREY M. GREENMAN, BAYER PHARMACEUTICALS CORPORATION, 400 MORGAN LANE, WEST HAVEN, CT, 06516, US

(73) Assignee: Bayer Pharmaceuticals Corporation, West Haven, CT (US)

(21) Appl. No.: 10/683,092

(22) Filed: Oct. 10, 2003

Related U.S. Application Data
(63) Continuation of application No. 09/665,449, filed on Sep. 19, 2000, now abandoned.

(51) Int. Cl. A01K 47/06

(52) U.S. Cl. 449/20

(57) ABSTRACT

Disclosed herein is a beehive entrance dimensioned or equipped with an entrance gate device comprising an anti-parasitic agent having a means for restricting bees from flying into the hive, and compelling the bees to effectively contact the anti-parasitic agent

### BACKGROUND OF THE INVENTION

1. Field of the Invention

The present invention relates to an entranceway to a beehive, in protecting bees against parasitosis caused by parasitic mites and other predacious insects. More specifically, the invention relates to a means for controlling parasites of beehives by means of dimensioning the entrance to the beehive or equipping it with a device to which is applied anti-parasitic agents.

2. Brief Description of the Prior Art

Typically the entrance to a beehive (flight hole), located at its lower part, connects the interior of the hive inhabited by the bees (with their honeycombs, broods and honey stocks) with the environment outside the beehive. Generally, the flight hole is provided between the lowermost box and the floor to allow entry to and exit of bee from the hive. As bees reach the flight hole, there is a change in their activity and behavior. Bees, leaving the hive to seek food, take off and start to fly as they exit the hive, while bees returning to the hive, particularly those laden with nectar and pollen, land and walk through the entrance into the hive.

Heretofore, this change in behavior has not been harnessed in protecting the hives from parasites and other undesirable elements which penetrate the beehive via the flight hole. Presently, the protection of hives against penetration through the flight hole has been by means of guard bees posted at the flight hole, or synthetic means including the use of various pesticidal agents. These agents have been applied to the bees or their environment by means other than provided by this invention. By the present invention there is disclosed a novel means of providing anti-parasitic agents, which aids in preventing penetration or reducing parasitosis.

### SUMMARY OF THE INVENTION

In accordance with the foregoing, the invention encompasses a beehive having an entrance, which is dimensioned or equipped with a device, and a process of using the same to control parasitosis. More specifically, the invention relates to a beehive comprising an anti-parasitic agent disposed at an entrance providing a passageway connecting the interior of the hive to its surroundings. The entrance is dimensioned or equipped with a device restricting bees from flying and compelling them to effectively contact the anti-parasitic agent.

In the present embodiment, the invention employs a combination of anti-parasitic agents and a compatible material, which is disposed at the entrance of the beehive. By the term “combination” is meant that the anti-parasitic agent is associated with the compatible material to produce a stable matrix that provides the anti-parasitic agent upon effective contact with the bees. By the term “compatible material” is meant that a material that is capable of being associated with the anti-parasitic agent to produce the stable matrix. By the term “effective contact” is meant that when the bees walk or crawl through the entrance, they take up effective amounts of the pesticide. By the term “effective amount” is meant the amount that is sufficient to kill or otherwise control the parasites and other predatory elements, without harming the bees.

Also encompassed by the invention is a method of making the device comprising combining the anti-parasitic agent with a compatible material to provide a restriction means that keeps the bees from flying. Preferably, one can make the device by impregnating the compatible material with the anti-parasitic agent. In the presently preferred embodiment of the invention, the device comprises a polyvinyl chloride, which is impregnated with coumaphos. The device is put in a form that has a restricting means comprising apertures or runs dimensioned to keep the bees from flying.

Also encompassed by the invention is a process for combating parasitosis comprising applying anti-parasitic agents to the beehive entrance, which is dimensioned or equipped with a device to have a restricting means. Illustratively, the anti-parasitic agent can be disposed at the dimensioned entrance by applying a coating, a film or fibrous material containing the anti-parasitic agents to an entrance or impregnating the material used to make the entrance. Alternatively, the anti-parasitic agent can be disposed by applying the coating, film or fibrous material containing the parasitic material to an entrance device or impregnating the entrance device with the anti-parasitic agent that is attached to the entrance. In any event, the entrance including the device is such as restricts flight of the bees in order to compel them to contact the pesticide. In a preferred embodiment, the invention encompasses an entrance device comprising a pesticide-impregnated polyvinyl chloride molding having runs therein, which is secured to the entrance, which can act as a passageway connecting the interior of the hive to its surroundings.

The invention is useful for a wider variety of beehives, having entranceways, which are mostly Langstroth hives or modifications thereof. Beehives are typically a type of box or supers in which multiple frames are stored. The frames are wood or plastic boards hung in the hive onto which honeybees draw out wax honeycomb.

The invention is advantaged in that one, including the untrained in bee keeping, can easily, rapidly and correctly fit the device to the beehive. At present, beehives must be opened for treatment, and stings are common even if protective clothing is worn. The invention is further advantaged in that in its use, the release of the active ingredient is regulated and at an appropriate level, because the number of passages through the run depends on the number of bees in the population. Small bee populations with fewer bees receive less of the active ingredient. Residues of the active ingredient in honey and wax are much lower than with treatment methods in common use at present, where the anti-parasitic agent is applied inside the hive. In effect, the pesticides are released slowly from the device in sufficient concentration to kill parasites residing on the bees or within the hive, but in low enough concentrations not to have toxic effect on the bees or their honey. Finally, the invention is advantaged in that removal or replacement of the device can be easily done during or at the end of treatment.

These and other aspects of the invention are described more fully hereunder.

### DETAILED DESCRIPTION OF THE INVENTION

As set forth above, the present invention relates to a beehive having an entrance, which is dimensioned or equipped with a device for restricting bees from flying into the beehive, and a process of using the same to control parasitosis. In the present embodiment, the entrance dimensioned or equipped with a device comprises an anti-parasitic agent disposed at its entrance which can provide a passageway connecting the interior of the hive to its surroundings, which restricts the bees from flying and compelling them to effectively contact the anti-parasitic agent. Distinctly, the invention harnesses a feature of bees' natural behavior. That is, bees always use propolis to narrow the apertures between the interior habitat and the outside world (for example in hollow trees). In narrowing the apertures, the bees can no longer fly straight into the interior but have to crawl instead. In accordance with this recognition, the hive is constructed with an entrance or is equipped with an entrance device having a passageway restricting the flight of bees and compelling them to walk. In the present embodiment of the invention, the entrance is dimensioned or equipped with a device, which has runs. Preferably the entrance is equipped with a device in the form of a block material having runs therein.

The anti-parasitic agent can be selected from the group consisting of carbamates, e.g. propoxur, carbaryl; formamidines, e.g. chlordimeform; organophosphates, e.g. trichlorfon/metrifonate, coumaphos, bromfenvinphos, tetrachlorvinphos; pyrethroids, e.g. cyfluthrin, permethrin, tetramethrin, deltamethrin, fluvalinate, cypermethrin, alphamethrin, flumethrin, fenvalerate, cyhalothrin, resmethrin, flucythrinate; juvenile hormone agonists, e.g. pyriproxyfen, metoprene, hydroprene, fenoxycarb; chitin synthesis inhibitors, e.g. triflumuron, diflubenzuron, hexaflumuron, lufenuron, fluazuron, flufenoxuron; triazine derivatives, e.g. cyromazine; amidines, e.g. amitraz, cymiazole; avermectins and milbemycins, e.g. ivermectin, abamectin, moxidectin, doramectin, eprinomectin, and phenylpyrazoles, e.g. fipronil.

The invention is further illustrated without limiting it to coumaphos as the anti-parasitic agent. Coumaphos is typically a solid organophosphorous compound that can be combined with a compatible material such as plastic, in an amount sufficient to maintain the stability and integrity of the combination. The resulting combination, upon contact with infesting pests, releases sufficient coumaphos to control the pest for a period of a day to 8 weeks, and preferably up to about 3-8 weeks. Typically, an amount of 1 to 20 and preferably 2.5 to 10 percent of coumaphos based on the total weight of the combination can be used.

The material can be any compatible material selected from the group consisting of polyvinyl chloride (PVC), polyurethane, polyvinylidene chloride and vinyl compounds. An amount of 40 to 60 and preferably 45 to 55 percent of the compatible material based on the total weight of the combination can be used. Usually employed with the compatible material is a plasticizer selected from the group consisting of triethyl citrate, acetyl tributyl citrate, citrate esters, dioctyl phthalate and diethylhexyl phthalate. Amounts of 5 to 40 percent and preferably 25 to 35 percent of the plasticizer based on the total weight of the combination can be employed. Other components can be incorporated in the combination. For example, dyes, pigments, lubricants, flakes, fillers, antioxidants and ultraviolet stabilizers can optionally be incorporated.

The components can be formed into the combination by any convenient method including impregnating the material with coumaphos by molding and preferably by injection molding. Preferably the coumaphos is incorporated by embedding it in the plastic material.

In the present embodiment of the invention, the device is configured to fit an entrance to a beehive and to provide a passageway between the beehive and its surroundings. The entrance and/or entrance device can be of any convenient shape that compels the bees to crawl while safely allowing ingress and egress to the hive. Typically, the entrance or device is configured to have a run which is effective to restrict the bees from flying into the hive. Illustratively, the run has a clearance, which does not significantly exceed about 1.5 cm. The minimum width of the run can be fixed on the basis of the size of the drones, which need clear passage. Typically, the minimum width is about 6 to 7 mm. Since the entrance is also used for gas exchange and for respiration, its cross-section must be such as would allow efficient gas exchange. Typically, its cross-section must not be less than about 10 to 15 cm².

In preparing the device, any convenient method, preferably impregnating the material with coumaphos by molding, e.g., injection molding can be employed. Preferably coumaphos is incorporated by embedding it in the plastic material. The coumaphos or other anti-parasitic agents are incorporated in amounts sufficient to provide an effective contact with bees, which amount can be used to control parasites on the bees or in the hive.

Parasites that can be controlled in accordance with this invention include parasitic honeybee mites and other hive parasites: e.g. Tropilaelaps clareae, Tropilaelaps koenigerum, Euvarroa sinhai, Euvarroa wongsirii, Varroa jacobsoni, Varroa underwoodi, Varroa rinderreri, Aethina tumida.

In the practice of the invention, the device can be secured to entrance by any convenient means. The device can be equipped to the hive preferably by fixed or removable means such as sliding means, fastening means, a compartment means or the like. The device can be disposed at the entrance by a fixed or removable means of securing the same. Illustratively, the device can be held in place by friction, screws, nails, adhesives or the like.

As the bees pass though the device in place, the anti-parasitic agents impact the bees, as follows: Anti-parasitic agents are taken up from the surface of the device and kill parasites entering the hive. Alternatively, the bees take up anti-parasitic agents from the surface of the device as they enter the hive. Consequently, the anti-parasitic agents either kill parasites on the contacted bees, or are distributed from the bees entering the hive to other bees in the hive via social physical contact and kill parasites already inside the hive.

Generally, the period of use of the device will depend on the period of development of the parasites and of the bees. Treatment can be carried out such that all the development stages of the parasite on the adult bees or brood have exposure to treatment. The treatment can be carried out twice per year at intervals of about 1 to 56 days each. The polyvinyl entrance gate was prepared by injection molding of a polyvinyl chloride premix obtained from Solvay Medical Tubings. A placebo and 510% sample were made. The device as shown in FIG. 1 has a dimension: length being 195 mm; depth being 25 mm; external height being 14 mm and internal height being 9 mm. In testing the efficacy of the device, it was the entrance gate device using a polyvinyl chloride entrance gate impregnated with 10% coumaphos which had an average efficacy in the hive of 97.1% against Varroa jacobsoni.

Although the invention has been described above in detail for the purpose of illustration, it is to be believed that such detail is solely for that purpose. As such, variations can be made therein by those skilled in the art without departing from the spirit and scope of the invention except as it may be limited by the claims.

What is claimed is:

1. A beehive comprising an entrance for restricting bees from flying into the beehive and compelling them to contact an anti-parasitic agent disposed at the entrance.

2. The beehive of claim 1 wherein the entranceway is dimensioned or equipped with a device to provide a passageway.

3. The beehive of claim 2 wherein the entrance is the sole passageway connecting the interior of the beehive to its surroundings.

4. The beehive of claim 1 wherein the anti-parasitic agent is selected from the group consisting of carbamates, formamidine, organophosphates, pyrethroids, juvenile hormone agonists, chitin synthesis inhibitors triazine derivatives, amidines, avermectins and milbemycins, and phenylpyrazoles.

5. The beehive of claim 4 wherein the anti-parasitic agent is a carbamate.

6. The beehive of claim 5 wherein the carbamate is coumaphos.

7. An entrance device comprising a combination of an anti-parasitic agent and a compatible material disposable at a beehive entrance for restricting bees from flying into the beehive and compelling them to contact the anti-parasitic agent in the combination or disposed at the entranceway.

8. The entrance device of claim 7 which acts as a passageway connecting the interior of the hive to its surroundings.

9. The entrance device of claim 8 wherein the passageway is the sole passageway connecting the interior of the hive to its surroundings.

10. The device of claim 7 wherein the anti-parasitic agent is selected from the group consisting of carbamates, formamidine, organophosphates, pyrethroids, juvenile hormone agonists, chitin synthesis inhibitors triazine derivatives, amidines, avermectins and milbemycins, and phenylpyrazoles.

11. The device of claim 10 wherein the anti-parasitic agent is a carbamate.

12. The device of claim 11 wherein the carbamate is coumaphos.

13. The device of claim 7 wherein the material is selected from the group consisting of polyvinyl chloride, polyethylene, polypropylene, and polystyrene, wood and fiber.

14. The device of claim 7 wherein the material has a run that restricts bees from flying into the passageway.

15. A process for combating parasitosis, comprising applying an anti-parasitic agent to an entrance of a beehive which restricts bees from flying into the hive, and compelling the bees to contact the anti-parasitic agent.

16. A process for combating parasitosis comprising providing a beehive dimensioned or equipped with a device compelling bees to make an effective contact with the anti-parasitic agent.
